(19) United States
(12) Patent Application Publication
(10) Pub. No.: US 2015/0367820 A1
(43) Pub. Date: Dec. 24, 2015

(54) WIPER ASSEMBLY OF A MOTOR VEHICLE WINDOW COMPRISING A MOUNTING HEAD AND A DRIVE ARM

(71) Applicant: Valeo Systèmes d'Essuyage, Le Mesnil Saint Denis (FR)

(72) Inventors: Nicolas Kuchly, Talence (FR); Vincent Garibaldi, Riom (FR)

(73) Assignee: Valeo Systèmes d'Essuyage, Le Mesnil Saint Denis (FR)

(21) Appl. No.: 14/744,339

(22) Filed: Jun. 19, 2015

(30) Foreign Application Priority Data
Jun. 20, 2014 (FR) 1455678

(51) Int. Cl. B60S 1/58; B60S 1/34

(52) U.S. Cl. CPC B60S 1/583; B60S 1/3436; B60S 1/3481; B60S 1/3443

(57) ABSTRACT

A wiper of a motor vehicle window is disclosed. The wiper includes a mounting head adapted to be rotatably driven by a motorized shaft about a transverse axis of the mounting head, and a drive arm extending along a longitudinal axis between a proximal end pivotally mounted about an axis borne by said mounting head, and an opposite distal end which carries a wiper blade, where an elastic return means is provided to participate in maintaining the arm in position relative to the mounting head. The drive arm includes a shroud disposed at its proximal end and wholly encloses the mounting head. The shroud has projecting means on its inner face, cooperating with complementary means projecting from the outer face of the mounting head to form pivoting means of the arm around the head and means for holding the arm in position in various operating positions of the wiper assembly.

The present invention relates to a wiper assembly of a motor vehicle window comprising a mounting head adapted to be rotatably driven by a motorised drive arm adapted to carry a wiper blade at its end opposite the mounting head.

Such modules are known which more particularly equip the rear windows of motor vehicles. The arrangement of the wiper blade in the axial extension of the drive arm allows a significant surface area of the window to be cleaned with a single wiper assembly. This type of structure, however, has the disadvantage of being fragile, notably when the wiper blade must displace an amount of stagnant snow on the glass. The resulting torque may be excessive for the mechanical structure formed by the arm and by the mounting head, and wiper assembly can break, notably at the junction between the mounting head and the drive arm.

The present invention falls within this context and its purpose is to provide a sufficiently robust wiper assembly, notably for a rear window of a motor vehicle.

Furthermore, such wiper assemblies must be designed to provide a release mechanism, enabling the user to simplify the replacement of a wiper blade when it is worn. The user must be able to rotate the drive arm about an axis of articulation parallel to the window and borne by the mounting head, so as to disengage the blade from the window, and it is convenient for the user that the release position of the blade, inclined at an angle, may be retained mechanically, so that the user can have his hands free to replace the wiper blade.

The release system must be sufficiently secure, i.e. to enable the drive arm to be lifted only under a certain constraint, so as to prevent the drive arm from assuming a release position not deliberately wanted by the user, and notably when the vehicle is passing through a roller cleaning system, which may then result in breakage of the wiper assembly if it rises during the cleaning operation.

The invention, as it was considered in the context of obtaining a sufficiently robust wiper assembly, also aims to provide an alternative to the detachable system that is efficient and secure.

The invention thus proposes a wiper of a motor vehicle window, comprising a mounting head adapted to be rotatably driven by a motorised shaft about a transverse axis of the mounting head, and a drive arm which extends along a longitudinal axis between a proximal end adapted to be pivotally mounted about an axis borne by said mounting head and an opposite distal end adapted to carry a wiper blade, elastic return means being provided to participate in maintaining the arm in position relative to the mounting head.

According to the invention, the drive arm includes a shroud which is disposed at its proximal end and wholly encloses the mounting head, said shroud having projecting means on its inner face, cooperating with complementary projecting means on the outer face of the mounting head to form pivoting means of the arms around the head and means for holding the arm in position relative to the head in different operating positions of the wiper assembly.

According to various features of the invention, taken alone or in combination:
the shroud comprises at least a rear end portion adapted to house the mounting head and having side walls facing one another and a transverse end wall which connects the side walls and which has a slightly curved shape to wholly surround the mounting head;
the side walls, near the transverse end wall, are cut diagonally, so that the lower edge of the rear end portion forms a bevel;
the inner face of at least one side wall has a concave recess machined in the material from the upper edge of the rear end portion;
the projecting means borne by the arm comprise an axial rib that extends under said recess to the inclined wall forming the lower edge of the corresponding side wall;
the shroud of the drive arm has various thicknesses, such that a rear receiving area of the head, of lesser thickness, and a front force transfer area, of greater thickness, are separated by junction lines forming a shoulder facing one another;
each junction line has a specific profile wherein a cylindrical seat forms part of said pivoting means, and wherein a straight portion extending at the cylindrical seat forms part of the means to hold it in position;
the complementary means borne by the mounting head to form said pivoting means consist of cylinder portions arranged laterally on either side of the head to be housed in one of the cylindrical seats, respectively;
the cylindrical seat has straight guide walls, facing one another, and a circular stop wall which connects them by forming a semicircle open towards the rear receiving area of the head;
the elastic return means consist of a coil spring mounted at a first end on the mounting head and the second end of which is mounted on the drive arm;
the end turns of the coil spring are extended parallel to the line of action of the spring by a branch at the free end of which fastening means are formed for attachment to the mounting head and to the arm, said branches being straight;
the mounting head comprises a body having a bore cooperating with the motorised shaft and a tab, hollowed axially between two lateral uprights to allow clearance for the spring, a latching pin which extends transversely from the tab between the two lateral uprights being provided for hooking the spring;
an additional thickness of the outer face of the lateral uprights of said tab and the inner face of the side walls of the arm which extend opposite, form parts of the means to hold the arm in position relative to the head;
the shroud of the arm and the mounting head further feature complementary means for disengaging the arm, said means notably comprising a ramp integral with the inner face of the arm and guide means borne by the mounting head;
the ramp has two planes of different inclinations, a first inclined plane, having a first inclination value, being formed from the upper edge of the arm, and a second inclined plane, having a second inclination value less than the first inclination value, extending the first inclined plane;
the mounting head and the connecting arm are arranged in a so-called operating position such that the transverse axis of the mounting head and the longitudinal axis of the arm are substantially perpendicular;
the arm is able to assume a stable release position wherein the longitudinal axis of the arm is offset angularly by an angle less than or equal to 30° relative to the transverse axis of the mounting head.

Other features and advantages of the invention will become apparent on reading the detailed description of an embodiment which follows and for better understanding, reference is made to the annexed drawings wherein:

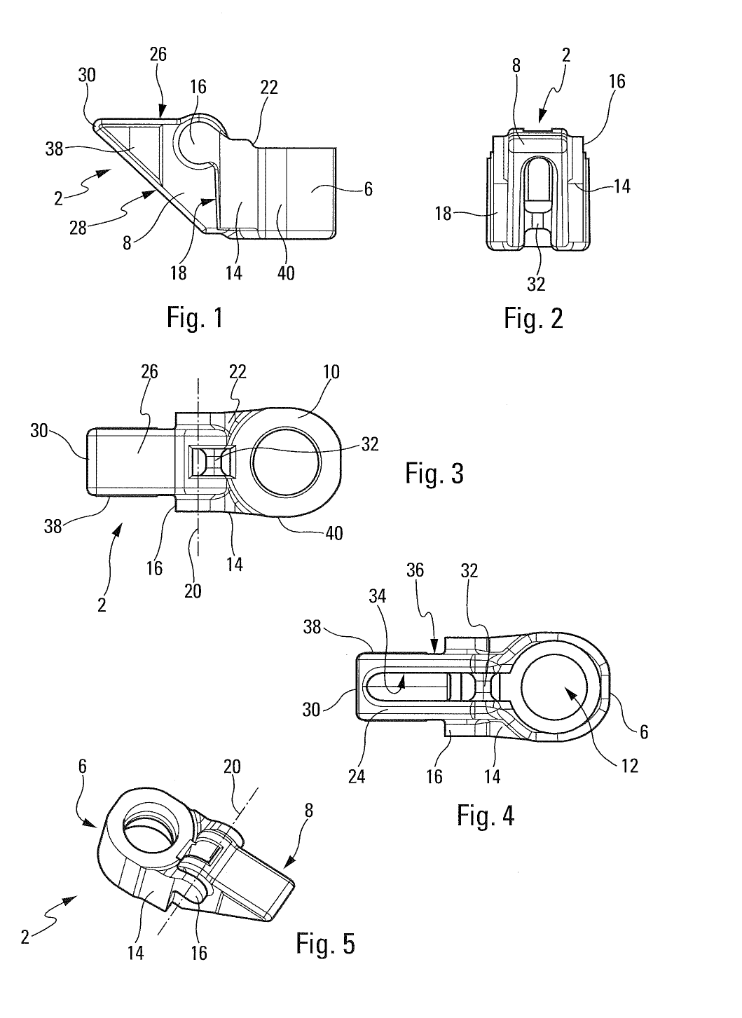

FIGS. 1 to 5 are front, side, top, bottom and perspective views, respectively, of a mounting head for wiper assembly according to a first embodiment of the invention;

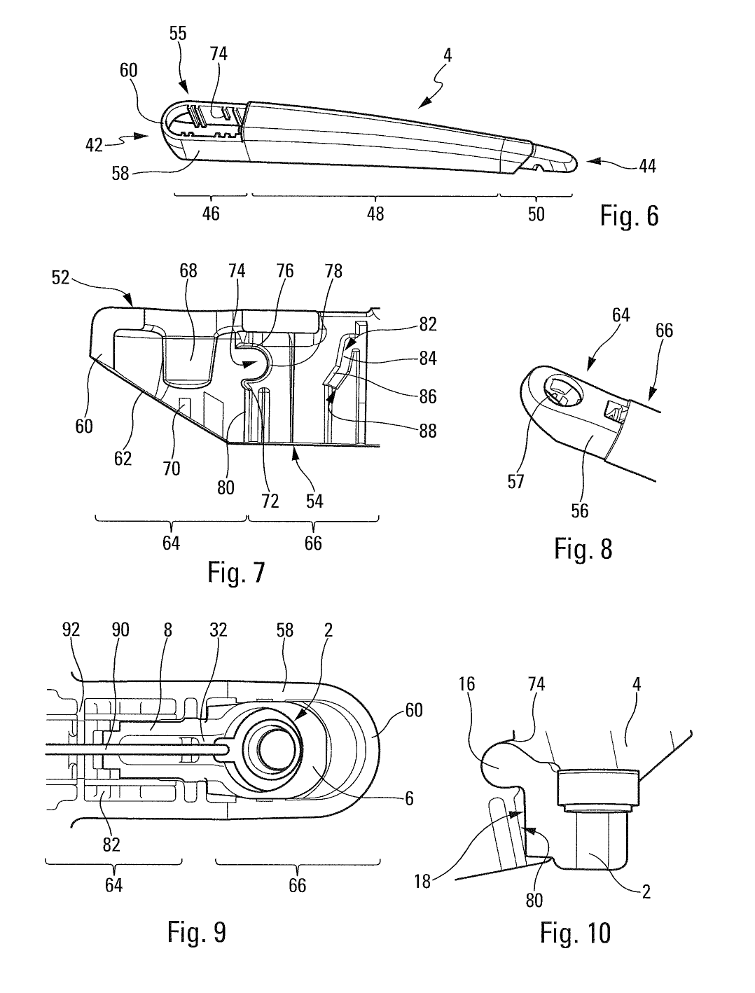

FIG. 6 is a perspective view of the drive arm adapted to be mounted, in the wiper assembly according to the first embodiment of the invention, on the mounting head illustrated in the preceding figures, said figure making particularly visible a proximal end part through which the arm is adapted to cooperate with the mounting head and a distal end part on which the wiper blade is attached;

FIG. 7 is a cross-sectional side view of said proximal end part of the arm of FIG. 6;

FIG. 8 is a detailed view in perspective of the proximal end part of the arm with a cover;

FIGS. 9 and 10 are views of the wiper assembly when the head and the arms are assembled in a so-called delivery position of the invention, FIG. 9 being a bottom view while FIG. 10 is a longitudinal, cross-sectional side view, centred on the articulation means of the arm and the head;

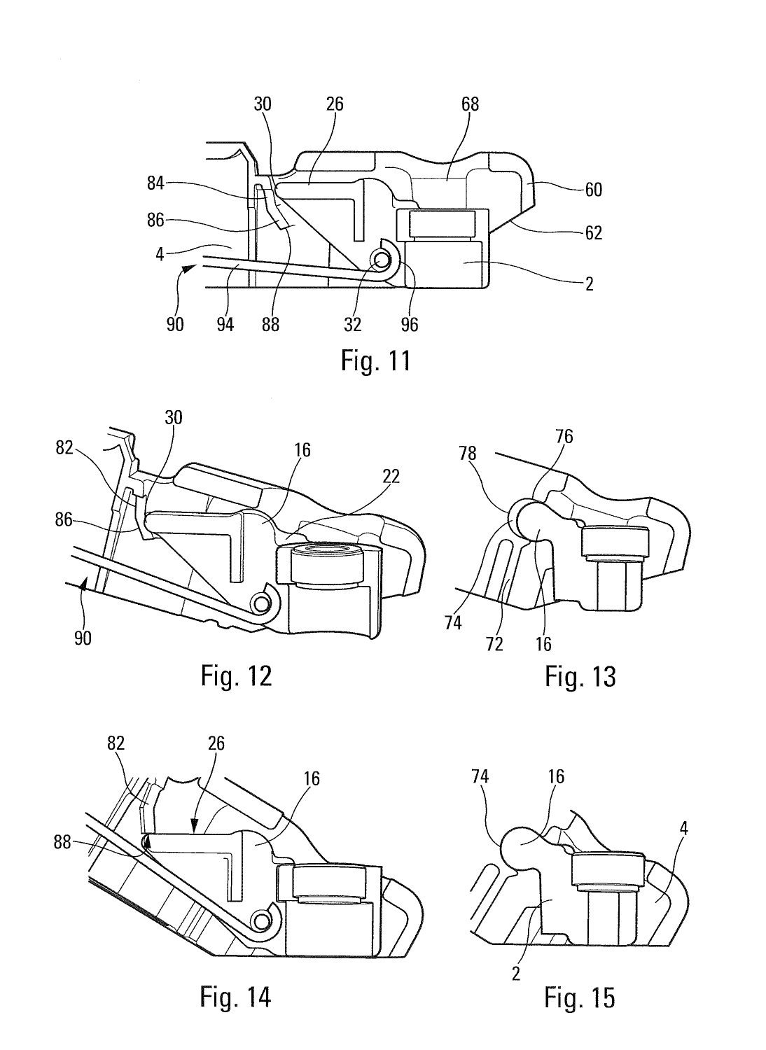

FIG. 11 is a side view of the wiper assembly when the head and the arms are assembled in an operating position, the arm being represented here in a cross-sectional view for greater visibility;

FIGS. 12 and 13 are views of the wiper assembly when the head and the arms are assembled in a so-called intermediate release position of the invention, FIG. 12 being a bottom view similar to that of FIG. 11 while FIG. 13 is a longitudinal, cross-sectional side view, centred on the articulation means of the arm and the head;

FIGS. 14 and 15 are views of the wiper assembly when the head and the arms are assembled in a so-called stable release position of the invention, FIG. 14 being a bottom view similar to that of FIG. 12 while FIG. 15 is a longitudinal, cross-sectional side view, centred on the articulation means of the arm and the head.

As illustrated in the figures, the wiper assembly comprises a mounting head 2, a drive arm 4 cooperating with said head, and a wiper blade, not shown here and which is mounted on the arm opposite the mounting head.

The mounting head is made integral with a motor shaft, not shown here and which extends substantially perpendicular to the window to be wiped, so as to impart an alternating rotational movement to this mounting head and to the corresponding wiper assembly.

The mounting head 2, illustrated alone in FIGS. 1 to 5, is formed from one single piece having a base 6, at the level of which the head is notably rendered integral in rotation with the motor shaft, and a connecting tab 8 to the drive arm, which extends substantially perpendicularly to said base. The outer surface of the mounting head features knurls adapted to cooperate, as will be described hereinafter, with ribs formed inside the drive arm, these complementary means projecting from the arm and from the head being arranged to facilitate maintaining the arm in position relative to the head and the load transfer between these two components of the wiper assembly.

The base has a substantially cylindrical body 10 pierced in its centre with a through bore 12, and two legs 14 arranged facing one another so as to radially extend said body and to surround the connecting tab.

The axis of the through bore is coincident with the axis of rotation of the motorised shaft. This axis of the mounting head shall be referred to as the transverse axis, and it will be understood that it corresponds to the axis of rotation of the wiper assembly. The through bore has a diameter substantially equivalent to the outer diameter of the motorised shaft, and the fitting means, for example a conical shape, to cooperate with complementary means borne by the motorised shaft, so as to ensure the rotational drive of the mounting head by the shaft.

Each leg 14 has a cylinder portion 16 whose axis is perpendicular to the transverse axis of the mounting head, disengaged from the leg by a material cutout under the cylinder portion which forms a straight-edged abutment portion 18. These two cylinder portions borne by the mounting head have a common axis 20 which forms, as will be described below, a pivot axis of the connecting arm relative to the mounting head.

The connecting tab 8 is formed in the continuity of the cylindrical body, and it is centred between the two legs 14, such that the cylindrical body has a larger transverse dimension than the tab. A material cutout 22 is formed on the upper face of the cylindrical body, set back from the cylinder portions 16, to form a bearing face for the screwing means of the mounting head with the motorised shaft.

The connecting tab 8 thus extends the base radially, along a first axis. The tab comprises two lateral uprights 24 which extend facing one another, by connecting at right angles to the outer surface of the cylindrical base, and it further comprises an upper wall 26 that covers both uprights. The side uprights are integral with the cylinder portions which project laterally beyond the outer faces of the lateral uprights. Each lateral upright has a substantially triangular planar shape, a first side of which is integral with the base of the head, a second side is integral with the upper wall and a third side, and the front face 28 of the lateral uprights is inclined by an angle substantially equal to 45° relative to the first axis. A rounded edge 30 is formed at the junction of each of lateral uprights with the upper wall.

As is illustrated and notably visible in FIGS. 2 and 4, the tab has a hollow shape leaving a passageway between the lateral uprights and under the upper wall, for a spring as will be described later. The tab comprises a latching pin 32 on one end of this spring, the latching pin being disposed transversely between the inner faces 34 of lateral uprights 24, inside the tab.

The inner faces 34 of the lateral uprights are defined as those being rotated with respect to one other, and the outer faces 36 of these lateral uprights being the opposite faces, adapted to be opposite the arm when the mounting head cooperates with the drive arms.

The projecting position maintaining and load transfer means borne by the mounting head comprise first knurls 38 formed by an extra thickness on the outer face of each lateral upright of the tab, and they comprise second knurls 40 which are formed on the outer surface of the cylindrical body, and which extend parallel to the transverse axis of the mounting head. Furthermore, third knurls extend parallel to this same axis of rotation under each of the cylinder portions of the base, formed by the straight-edged abutment portion 18.

The drive arm 4, illustrated alone in FIGS. 6 to 8, has an elongated shape which extends substantially longitudinally, along a longitudinal axis of the arm, between a proximal end 42 cooperating with the mounting head and one distal end 44 adapted to support a wiper blade, not shown here. From the proximal end to the distal end, the arm comprises in succession a rear end portion 46, adapted to surround the mounting head, a central portion 48 and a front end portion 50, carrying the wiper blade, said central portion connecting the rear end portion to the front end portion. For what follows, the lower edge 52 of the arm is defined as the edge adapted to be turned toward the window to be wiped when the wiper assembly is in position on the vehicle, and an opposite upper edge 54 is defined. A transverse axis of the arm is defined as an axis perpendicular to these lower and upper edges, and to the longitudinal axis of the drive arm.

The rear end portion 46 comprises a shroud 55 integral with the central portion and cover 56 adapted to overlap the upper edge of the shroud and having at least one hole 57 to allow access to the shroud when the cover is in position.

The shroud comprises two side walls 58 connected to the back of the shroud by a slightly curved, transverse end wall 60. The side walls, near the transverse end wall, are cut diagonally, so that the lower edge of the shroud portion forms a bevel 62.

The shroud defines a rear receiving area 64, of lesser thickness, and a front force transfer area 66, of greater thickness.

In the rear receiving area 64, every side wall presents, from the upper edge to the opposite lower edge, a concave recess 68 machined into the material, and an axial rib 70, that extends under this recess to the inclined wall forming the lower edge of the side wall.

On each side wall, the junction between the rear receiving area and the front force transfer area, for which the side wall has different thicknesses, consists of a shoulder forming edge 72 and the junction has a specific profile in its upper part so that the edge forms a cylindrical seat 74. This cylindrical seat has straight guide walls 76, facing one another and which extend substantially along the longitudinal axis of the arm, and a circular stop wall 78 which connects them forming an open semi-circle toward the proximal end of the arm. As shown in the figures, the lower straight guide wall of the cylindrical seat is extended perpendicularly by the lower part of the shoulder which is a straight portion 80.

In the front force transfer area 66, every side wall features a rib which protrudes inwardly from the arm forming a ramp 82. Advantageously, the ramp has two planes with different inclinations in relation to the longitudinal axis of the arm. A first inclined plane 84, having a first inclination value, is formed from the upper edge of the arm, and a second inclined plane 86, having a second inclination value, extends the first inclined plane. The first inclined plane extends above the second inclined plane, so as to form a ramp from the upper edge of the arm up to mid-height of the latter. The first inclination value is greater than the second inclination value, and, by way of example, a first inclination value substantially equal to 80° and a second inclination value substantially equal to 45° can be foreseen.

Advantageously, the lower end 88 of the ramp 82 is cut so that the end face has an angle, with the face of the second inclined plane turned toward the back of the arm, more than 90°. The advantage of such an orientation will be described in greater detail in the functional description of the wiper assembly.

It can be observed that, in the longitudinal axis of the arm, in the direction from the proximal end to the distal end, a receiving portion of the head, the cylindrical seat, the axial rib, and the ramp have been successively placed in the shroud.

The wiper assembly also includes, besides the arm and the head, a coil spring 90, which is mounted on the latching pin at a first end and the second end of which is mounted on the arm, and a wiper blade, not shown, mounted in a conventional manner at the distal end of the arm.

The central portion of the arm 48 has various stiffening ribs 92 of which one is provided with an opening to accommodate the second end of the spring. The other ribs extend across the arm, although it is understood that their height ensures that they do not interfere with the passage of the spring.

The spring 90 is a coil spring, the end turns of which are extended parallel to the line of action of the spring by a branch 94 at the free end of which fastening means are formed for attachment to the mounting head and to the arm. The attachment means arranged for attachment to the arm have a shape adapted to cooperate with the receiving hole formed in one of the ribs of the central portion of the arm, while the fastening means arranged for attachment to the mounting head are in the form of a C-shaped loop 96, so that this semi-circle shape can engage around the latching pin 32 housed in the tab of the mounting head.

We will now describe the cooperation of the arm and mounting head in different operating positions permitted by the wiper assembly according to the invention. These various positions include a delivery position, visible in FIGS. 9 and 10, an operating position, visible in FIG. 11, an intermediate release position, visible in FIGS. 12 and 13, and a stable release position, visible in FIGS. 14 and 15.

In each of these positions, it can be observed that the base 6 of the head is housed in the rear receiving area 64, of lesser thickness, and that the head is thus protected by the side walls 58 and by the transverse end wall 60 that surrounds it, and that the tab 8 extends into the front force transfer area 66 of the arm, of greater thickness.

Furthermore, in each of these positions, the cylinder portions 16 arranged in a projecting manner on the mounting head cooperate with the cylindrical seats 74 formed on the inner surfaces of the arm, thereby defining a pivot axis of the arm relative to the mounting head by the cylinder/cylinder relationship. Axial stops are formed, in one direction, by the side walls 58 of the arm, in another direction by the straight guide walls 76 of the cylindrical seat, and in a last direction by the circular stop wall 78 of the cylindrical seat and the action of spring 90. As will be described below, according to certain positions of the wiper assembly, the cylinder portions 16 can slide in the corresponding cylindrical seats 74 but both elements are still in contact in order to subsequently return into position.

The delivery position is illustrated in FIGS. 9 and 10. The spring 90 is mounted between the two latching pins, the first borne by the central portion of drive arm and the second 32 borne by the tab 8 of the mounting head. The arm is arranged around the mounting head, so that the rounded edge 30 of the front end of the tab is in contact with the upper edge of the ramp 82. In this position, the transverse axis of the drive arm and transverse axis of the mounting head are not parallel, such that the transverse axis of the drive arm makes a negative angle with the transverse axis of the mounting head. The inclined plane of the ramp and the force of the coil spring prevent the mounting head from rotating so that it returns inside of the arm. A stop is provided to prevent the head from rotating in the opposite direction, here in the clockwise direction in FIG. 10. This stop is formed by contact with the third knurl, i.e. the straight-edged abutment portion 18 of the mounting head, against the straight portion of the shoulder 80 formed on the arm at the junction between the rear receiving area 64 and the front force transfer area 66. Thus, under the action of the spring, which tends to press the straight edge against the shoulder, the delivery position is stable. This allows the head not to disengage from the arm during transport.

The operating position is illustrated in FIG. 11. The drive arm extends along an axis substantially perpendicular to the axis of the bore of the mounting head and therefore to the axis of the motorised shaft. The rounded edge 30 of the front end of the tab is in contact with the first inclined plane 84 of the ramp, and in this area of the tab, the first knurls 38 of increased thickness on the lateral uprights 24 of the tab are arranged against the inner face of the side walls of the arm. Furthermore, the second knurls 40 borne by the body of the head are in contact with the axial ribs 70 arranged in the rear receiving area of the arm. The interaction of the knurls borne by the head and the ridges borne by the head ensures contact between the two components of the wiper assembly, and they limit the lateral movement of the head within the arm, thereby facilitating holding the components of the wiper assembly in position and the transfer of force between the arm and the head during operation of this assembly.

The intermediate release position is illustrated in FIGS. 12 and 13. It corresponds to an intermediate position between the operating position and the stable release position. In the intermediate position illustrated, the drive arm extends along an axis at a positive angle of approximately 15° with the perpendicular to the axis of the bore of the mounting head. The user holds the arm or the wiper blade and exerts a lifting force on them in relation to the mounting head, so that the arm pivots about the axis defined by the cylindrical seat of the arm. In this position, the rounded edge 30 of the end of the tab is in contact with the second inclined plane 86 of the ramp and each cylinder portion 16 emerges from the cylindrical seat 74, away from the circular stop wall 78 while remaining in contact with the straight guide walls 76.

The stable release position is illustrated in FIGS. 14 and 15. It corresponds to the position in which the user can release the arm or the wiper blade in order to replace the worn blade. In the stable position illustrated, the drive arm extends along an axis at an angle of approximately 30° with the perpendicular to the axis of the bore of the mounting head. The stable release position is obtained by the contact between the upper wall 26 of the tab and the lower end 88 of the ramp 82 while the spring 90 tends to bring the arm back into the operating position. In this position, it can be observed that each cylinder portion 16 is in contact with the stop wall 78 of the cylindrical seat 74. In addition, the bevel 62 of the rear end portion forms a firm stop against the structural assembly supporting the drive motor of the mounting head, so as to avoid excessive release, i.e. in this case release in excess of 30°. The drive arm can rotate around the mounting head and assume this stable release position owing to the concave recesses 68 machined in the side walls of the arm, in the rear end portion, which offer the arm sufficient clearance without it coming into contact with the mounting head.

The transition from the delivery position to the operating position is achieved by securing the mounting head 2 to the motorised shaft extending perpendicularly to the window. For this purpose, a screw driving head is passed through the hole 57 formed in the cover 56 covering the arm, so that it accesses screwing means suitable for securing the motorised shaft to the mounting head.

The concave recesses 68 formed in the side walls of the shroud of the arm allow for the passage of this screw driving head, as well as the material cutouts 22 formed on the base of the mounting head. The wiper blade is pressed against the window and the drive arm assumes a position substantially perpendicular to the axis of the bore of the mounting head and to the motor axis owing to the force in reaction to the contact of the window. The spring 90 is compressed slightly and provides a force which in turn tends to press the blade against the window.

Transition is made from the operating position to the intermediate release position, described above, by lifting the drive arm so as to rotate it around the axis defined by the cylindrical seat 74 the arm and the cylinder portions 16 of the mounting head. The coil spring 90 is loaded in tension, which requires some effort to raise the drive arm 4 sufficiently. It is understood that this sufficient amount of force to be provided, if calibrated so that it can be easily performed by any user of the vehicle, prevents any inadvertent lifting of the arm and the blade in undesired cases, for example under the effect of wind, or under the action of a vehicle cleaning roller. The presence of the second inclined plane 86 of the ramp, the inclination of which is smaller than that of first inclined plane 84, and requires that a greater effort be provided to move the rounded edge 30 of the tab 8 of the mounting head along this slope, may be sufficient to prevent the arm from rising significantly in undesired circumstances.

The transition from the intermediate release position illustrated to the stable release position is made by continuing to rotate the drive arm in relation to the mounting head that remains fixed, integral with the motorised shaft. In order to release the arm, the presence of second inclined plane 86 of the ramp, the inclination of which is smaller than that of first inclined plane 84, requires that additional force be provided in order to load the coil spring in tension. The hardness of the spring 90 generates a relative translational movement between the mounting head and the arm. While the head remains fixed, the arm moves forward under the wedge effect in the direction away from the head, substantially in the direction defined by the shape of the arm in the intermediate release position. The cylinder portions 16 borne by the head move back into the cylindrical seats 74 of the arm, i.e. they are no longer in contact with the circular stop wall 78, but remain engaged in the straight walls 76 of the cylindrical seats.

This translational movement between the arm and head in opposite direction continues if the user continues to exert sufficient force, and until the rounded edge 30 of the tab goes beyond the lower end of the ramp.

Once the rounded edge has gone past this lower end and it is no longer in contact with the ramp, the arm is pulled back by the effect of relaxation of the spring so that it produces a reverse translational movement between the arm and the head, in the direction toward one other, the cylinder portions 16 moving back against the stop walls 78 of the cylindrical seats 74. The firm stop formed by the contact of the bevel of the arm on the motor unit stops the user in his arm lifting action and the arm can be released. The upper wall 26 of the tab, which has passed below the lower end 88 of the ramp when the arm and head were brought together, forms a vertical stop when the arm returns to its operating position, the lower end of the ramp formed on the arm coming into contact with the upper wall of the tab of the mounting head.

Finally, when the blade is replaced, we return to the operating position by pressing on the arm so as to force it to rotate in relation to the head in the opposite direction to that performed in the preceding steps. The inclination of the lower end 88 of the ramp can be calculated so that, in the stable release position, the contact surface between the ramp 82 and the tab 8 is limited as much as possible so that the ramp can slide easily along the upper wall of the tab.

Furthermore, it is interesting that the contact area between the upper wall and ramp is arranged as close as possible to the rounded edge 30 of the tab. Under the effect of the vertical pressure on the arm, the arm moves translationally relative to the head, the ramp sliding along the upper wall until it no longer provides a stop and allows the arm to gradually return to the operating position, the rounded edge of the tab remaining in contact with the ramp during this return to position. Again, in order to allow the translational movement of the head relative to the arm, the cylinder portions 16 are moved in the cylindrical seats 74.

The user can push the arms until the wiper blade meets the window, in the operating position of the wiper assembly.

The above description clearly explains how the invention achieves the objectives it has set, and notably how it proposes a wiper assembly that is particularly rigid, ensuring efficient transmission of forces between the mounting head and the drive arm.

A drive arm is proposed that allows the mounting head to be covered, this enclosure also integrating means cooperating with this mounting head to form a rugged wiper assembly. These cooperating means also provide a stable release function enabling easy replacement of the wiper blade, and at a relatively shallow angle compared to the assemblies of the prior art. Advantageously, blockage occurs at approximately 30°. The wiper assembly thus extends less high in this stable release position, and therefore it is more resistant if a force is exerted on the blade and the drive arm.

Stable release is dependent on the shape and length of the ramp 82, and is obtained through contact between the upper wall 26 of the tab 8 and the lower end 88 of the ramp 82. By contrast with the solutions of the prior art, there is no longer any need for the line of action for rotation of the spring to extend beyond the axis of pivoting 20 of the connecting arm 4 with respect to the mounting head 2 in order to obtain this stable release position.

Of course, those skilled in the art may make various modifications to the structures of the wiper assembly, which have been described by way of non-limiting examples, notably in the form cooperating means of the arm and head, as long as they provide a rugged wiping assembly, within the context of a fully shrouded arm covering the mounting head and having, on its inner face, means to facilitate the transfer of force with the head and means facilitating a stable release position.

1. A wiper assembly of motor vehicle windows, comprising:
a mounting head adapted to be rotatably driven by a motorised shaft about a transverse axis of the mounting head; and
a drive arm which extends along a longitudinal axis between a proximal end adapted to be pivotally mounted about an axis borne by said mounting head and an opposite distal end adapted to carry a wiper blade, elastic return means being provided to participate in maintaining the arm in position relative to the mounting head,
wherein the drive arm features a shroud disposed at its proximal end and wholly enclosing the mounting head, said shroud having projecting means on an inner face, cooperating with complementary means projecting from an outer face of the mounting head to form pivoting means of the arm around the head and means for holding the arm in position relative to the head in various operating positions of the wiper assembly.

2. The wiper assembly according to claim 1, wherein the shroud comprises at least side walls facing one another and a transverse end wall which connects the side walls and which has a slightly curved shape to wholly surround the mounting head.

3. The wiper assembly according to claim 2, wherein the side walls, near the transverse end wall, are cut diagonally, so that the lower edge of the read end portion forms a bevel.

4. The wiper assembly according to claim 2, wherein the inner face of at least one side wall has a concave recess machined in the material from the upper edge of the shroud.

5. The wiper assembly according to claim 4, wherein the projecting means borne by the drive arm comprise an axial rib that extends under said recess to the inclined wall forming the lower edge of the corresponding side wall.

6. The wiper assembly according to claim 1, wherein the shroud of the drive arm has various thicknesses, such that a rear receiving area, of lesser thickness, and a front force transfer area, of greater thickness, are separated by junction lines forming a shoulder facing one another.

7. The wiper assembly according to claim 6, wherein each junction line has a specific profile wherein a cylindrical seat forms part of said pivoting means, and wherein a straight portion extending at the cylindrical seat forms part of the means to hold it in position.

8. The wiper assembly according to claim 7, wherein the complementary means borne by the mounting head to form said pivoting means consist of cylinder portions arranged laterally on either side of the head to be housed in one of the cylindrical seats, respectively.

9. The wiper assembly according to claim 7, wherein the cylindrical seat has straight guide walls, facing one another, and a circular stop wall which connects them by forming a semicircle open towards the rear receiving area of the head.

10. The wiper assembly according to claim 1, wherein the elastic return means consist of a coil spring mounted at a first end on the mounting head and the second end is mounted on the drive arm.

11. The wiper assembly according to claim 10, wherein the end turns of the coil spring are extended parallel to the line of action of the spring by a branch at the free end of which fastening means are formed for attachment to the mounting head and to the arm, said branches being straight.

12. The wiper assembly according to claim 10, wherein the mounting head comprises a base having a bore cooperating with the motorised shaft and a tab hollowed axially between two lateral uprights to allow clearance for the spring, a latching pin which extends transversely from the tab between the two lateral uprights being provided for hooking the spring.

13. The wiper assembly according to claim 12, wherein an additional thickness of the outer face of the lateral uprights of said tab and the inner face of the side walls of the arm which extend opposite, form parts of the means to hold the arm in position relative to the head.

14. The wiper assembly according to claim 1, wherein the shroud of the arm and the mounting head carry complementary specific position holding means for disengaging the arm, said means notably comprising a ramp integral with the inner face of the arm and guide means borne by the mounting head.

15. The wiper assembly according to claim 14, wherein said ramp has two planes of different inclinations, a first inclined plane, having a first inclination value, being formed from the upper edge of the arm, and a second inclined plane, having a second inclination value less than the first inclination value, extending the first inclined plane.

16. The wiper assembly according to claim 1, wherein the mounting head and the connecting arm are arranged in a so-called operating position such that the transverse axis of the mounting head and the longitudinal axis of the arm are substantially perpendicular.

17. The wiper assembly according to claim 16, wherein the drive arm is able to assume a stable release position wherein the longitudinal axis of the arm is offset angularly by an angle less than or equal to 30° in relation to the mounting head.
